(19) United States
(12) Patent Application Publication
(10) Pub. No.: US 2015/0366258 A1
(43) Pub. Date: Dec. 24, 2015

(54) Drink Preparation Method Using a Direct-View Type Dynamic Displaying Interface

(71) Applicant: Rex Poway Tseng, Taipei (TW)

(72) Inventor: Rex Poway Tseng, Taipei (TW)

(21) Appl. No.: 14/308,513

(22) Filed: Jun. 18, 2014

(51) Int. Cl. A23L 2/52; G05B 15/02

(52) U.S. Cl. CPC A23L 2/52; G05B 15/02

(57) ABSTRACT

A drink preparation method using a direct-view type dynamic displaying interface, i.e., the user manually pours water into the drink preparation container filled with raw material and placed on the electronic scale; during the pouring, the electronic scale collects the drink weighing information; a client-end device having wireless transmission function is connected to the electronic scale and the server; the client-end device computes the drink weighing information and draws a flow rate curve with diagrammed time and weight; a control group is selected from the drink preparation groups captured by the server and the drink weighing information of the control group is synchronously compared to for direct-view type preparation based on the planned flow rate curve; the drink weighing information of the preparation process can be saved for record and review, comparative learning, or sharing and discussion, so as to provide an aid for beginners to learn preparation of coffee, scented tea, wine etc and quickly reach the level of experts.

### BACKGROUND OF INVENTION

1. Field of the Invention

The present invention relates generally to a drink preparation method using a direct-view type dynamic displaying interface, and more particularly to a visualized drink preparation technique using an electronic scale to display the weight and time.

2. Description of Related Art

Drinks are manually prepared with special drink preparation containers, such as those used to prepare coffee or tea. And there are diversified preparation methods to produce various flavors. However, as such manual preparation methods are not standardized, it is difficult to produce consistent flavors every time. During the preparation process, factors like soaking time, quantity of water, quantity of raw materials etc will all affect the final quality of the drinks. Particularly, when preparing coffee with a filtering container filled with coffee powder, the operator shall apply different quantity of hot water during different phases of time. During the initial pouring phase, hot water is poured over the coffee powder for complete blooming, and then hot water is poured in large quantity or slowly so that the bloomed coffee powder can completely release different coffee aromas. However, in actual application, it is very hard to keep the consistency in every preparation. The main reason is that there are no quantified parameters to abide by for duplicate preparations. The affecting aspects include the flow rate, time, and weight change during the pouring phase, time of blooming, and when to stop pouring. To solve the consistency problem, an automatic coffee preparation machine can be used to prepare coffee with a fixed control mode. However, the cost of the machine is relatively high. On the other hand, as the preparation mode is fixed, there is only a limited range of use, and the machine may not be adaptable to other kinds of coffee drinks. It is also not beneficial for preparation tests, teaching, learning and experience sharing.

In the conventional coffee preparation method as described above, hot water is poured over the coffee powder to filter out coffee. It is a direct-view operation, but in actual operation, it is difficult for new users to make preparations as good as skilled users. If there are quantified preparation data and the preparation process can be displayed in a graphic interface, and a control sample is provided for synchronous control of the flow rate and time of preparation to minimize the inconsistency of coffee quality caused by the preparation process, it will be an optimal solution for the above-stated problems and shortcomings of the conventional preparation method. This is the objective of research and improvement for the inventor of the present invention as well as related manufacturers in this industry.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### SUMMARY OF THE INVENTION

In view of the above-stated shortcomings, the inventor of the present invention collected related information, made deliberate evaluations as well as numerous tests and modifications to produce the invention based on his experience accumulated during years of engagement in this industry.

The main objective of the present invention is to provide a drink preparation method using a direct-view type dynamic displaying interface, i.e., during preparation, a handheld electronic device is synchronously connected to the electronic scale and the server via wireless network, information of the weighing process is converted by the electronic scale into graphic display of time and weight, and a reference object captured by the server is imitated for preparation.

To realize the above objective, the present invention provides a drink preparation method using a direct-view type dynamic displaying interface, i.e., the user pours water into the drink preparation container filled with raw material and placed on the electronic scale; during the pouring, the electronic scale collects the drink weighing information; a client-end device having wireless transmission function is connected to the electronic scale and the server; the client-end device computes the drink weighing information and draws a flow rate curve with diagrammed time and weight; a control group is selected from the drink preparation groups captured by the server and the drink weighing information of the control group is synchronously compared to for direct-view type preparation based on the planned flow rate curve; the drink weighing information of the preparation process can be saved for record and review, compared learning, or sharing and discussion, so as to provide an aid for beginners to learn preparation of coffee, scented tea, wine etc and quickly reach the level of experts.

Based on the above technique, some improvements can be made to drinks having the problem of inconsistency for manually beginners or manual preparation. The client-end device is very suitable for preparations having a direct-view control group, and the preparation operation combined with a handheld mobile device with short-distance wireless networking fully utilizes the current networking convenience to overcome the problem of connection and realize the practicability and advancement as described above.

### BRIEF DESCRIPTION OF THE DRAWINGS

FIG. 1 is a system component diagram of the present invention.

FIG. 2 is a connected system diagram of the system components of the present invention.

FIG. 3 is a weight chart of the drink weighing information of the present invention.

FIG. 4 is a judgment mechanism process diagram of the present invention.

FIG. 5 is a display interface diagram of the handheld electronic device of the present invention.

### DETAILED DESCRIPTION OF THE INVENTION

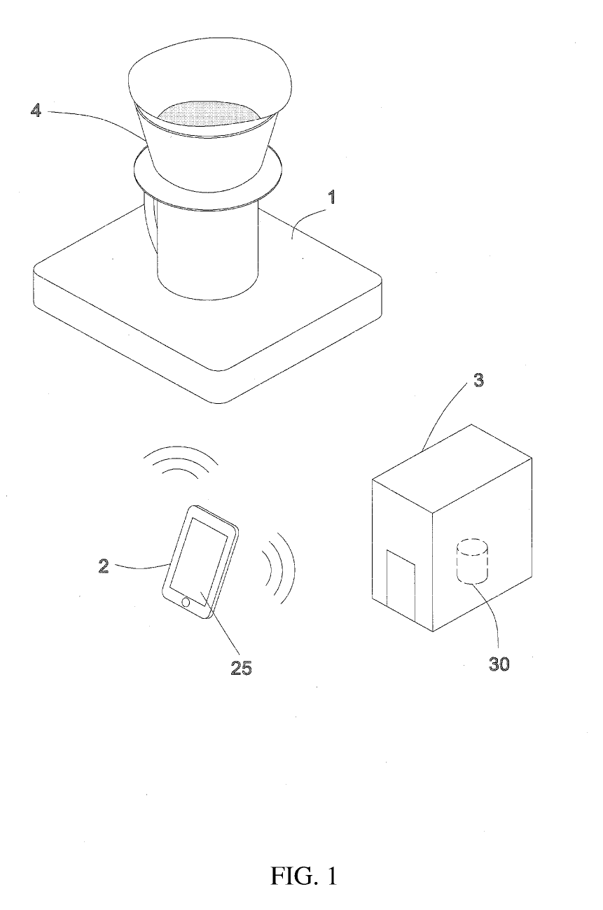

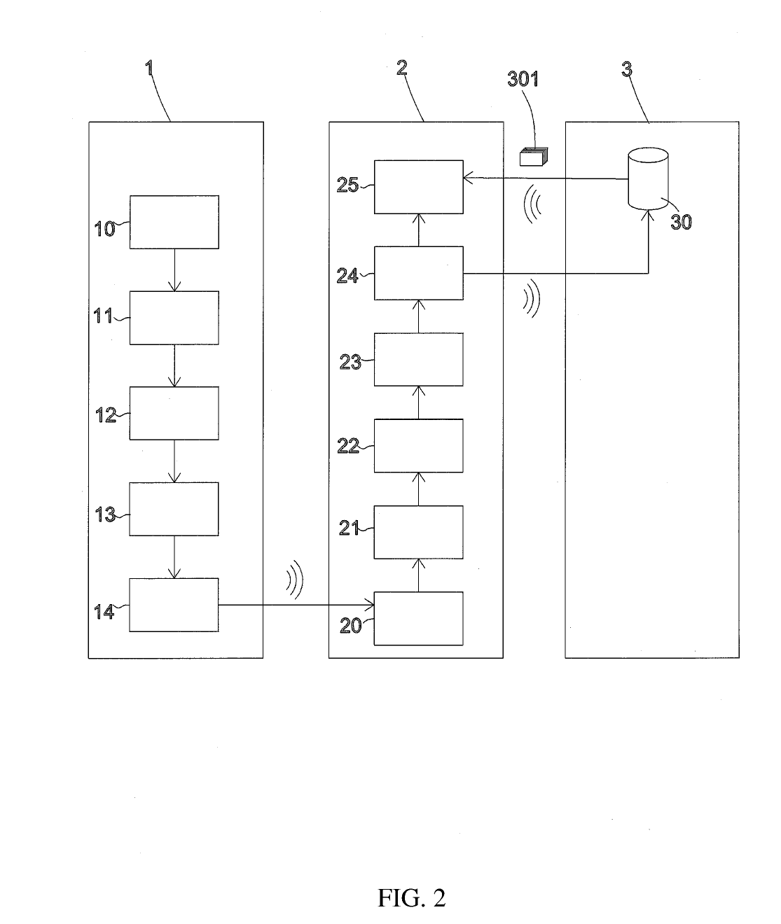

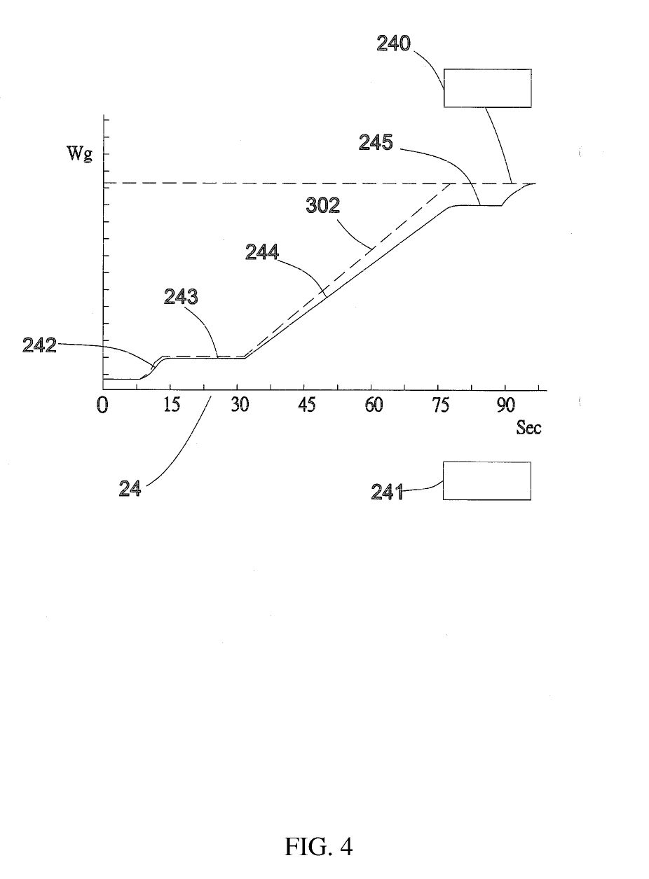

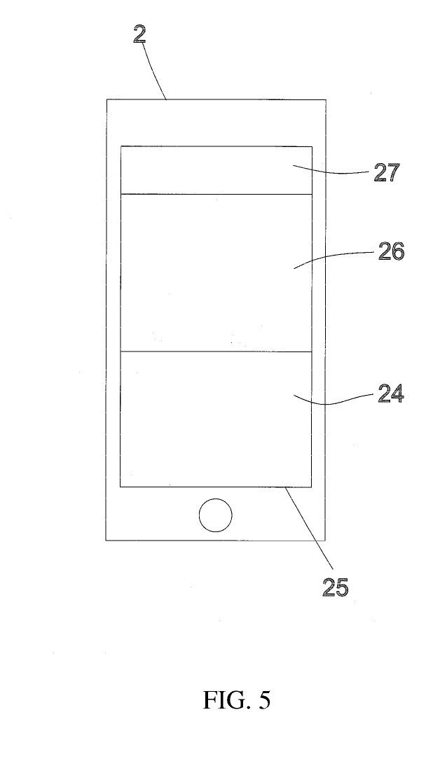

Referring to FIGS. 1-5, the present invention designs and provides a drink preparation method using a direct-view type dynamic displaying interface, i.e., the users pours water into the drink preparation container filled with raw material and placed on the electronic scale. During the pouring, the electronic scale collects the drink weighing information and wirelessly transmits the information to the client-end device in real time; the client-end device computes the drink weighing information and draws a flow rate curve with diagrammed time and weight; a synchronous comparison is made against the flow rate curve of the control group planned by the drink weighing information, so as to prepare consistent drinks through direct-view comparison and learning. Here, the raw material for drink preparation can be coffee powder, tea, wine, and food. The present invention mainly comprises: an electronic scale 1, a client-end device 2, a server 3.

The electronic scale 1 has a scale top to place the drink preparation container 4. The present invention uses a drink preparation container 4 filled with coffee powder as an example. The electronic scale 1 collects the real-time drink weighing information 10 of the manually prepared coffee drink placed on the electronic scale 1. The drink weighing information 10 is weighing information collected during the weighing process. The electronic scale 1 has a built-in load cell 11, a signal processing unit 12, a processor 13, and a Bluetooth chipset module 14. The load cell 11 senses the drink weighing information 10 of the drink placed on the electronic scale 1, and the information is magnified and filtered by the signal processing unit 12. During the preparation, the processor 13 detects the variations of the drink weighing information at regular intervals and sequentially transmits them to the Bluetooth chipset module 14. The drink weighing information 10 is wirelessly transmitted to the client-end device 2 in real time.

The client-end device 2 with wireless transmission function has a built-in Bluetooth chipset 20 matching the Bluetooth chipset module 14 of the electronic scale, a central processor 21, app 22 and a displaying interface 25. Through the Bluetooth chipset 20, the central processor 21 wirelessly receives the drink weighing information 10 transmitted by the Bluetooth chipset module 14 of the electronic scale 1, and send it to the app 22 having a judgment mechanism 23. The judgment mechanism 23 judges and computes the drink weighing information 10 and outputs it on the displaying interface 25, drawing a flow rate curve 24 on the displaying interface 25, with time as the horizontal axis and weight as the vertical axis. The judgment mechanism 23 further has a water suspension judgment unit 230, a water inlet judgment unit 231, and outputs the judgments to a graphic output unit 232. The drink weighing information 10 is respectively judged and filtered by the water suspension judgment unit 230 and the water inlet judgment unit 231. The water suspension judgment unit 230 judges if the drink weighing information 10 of the drink on the electronic scale 1 has increase of weight in one unit time. The water inlet judgment unit 231 judges if the drink weighing information 10 of the drink on the electronic scale 1 has an overweight exceeding the set value in one unit time. The drink weighing information 10 is output by the graphic output unit 232. The graphic output unit 232 outputs the judged and computed drink weighing information 10, and draws a flow rate curve 24 with diagrammed time and weight, and displays it on the displaying interface 25. The flow rate curve 24 indicates the average flow rate of the poured water. The flow rate curve 24 forms more than one Pour Section, Blooming Section and Suspension Section, and has a target weight displaying zone 240, a dynamic weight displaying zone 241. The displaying interface 25 is further configured with a multimedia displaying zone 26 that can display multimedia information and an information zone 27 that can display status. The client-end device 2 can be mobile phone, tablet computer, or any other type of handheld electronic device for the above purpose.

A server 3, to be connected with the client-end device 2, having a built-in database 30, stored with at least one control group of drink weighing information 301. The client-end device 2 can capture any control group of drink weighing information 301 stored in the database 30 of the server 3 and can save the drink weighing information 10 of the preparation process in the database 30 to become a control group of drink weighing information 301. The control group of drink weighing information 301 contains the planned flow rate curve 302 and multimedia archive information of photos, videos, texts, as a drink preparation record that can be shared with others.

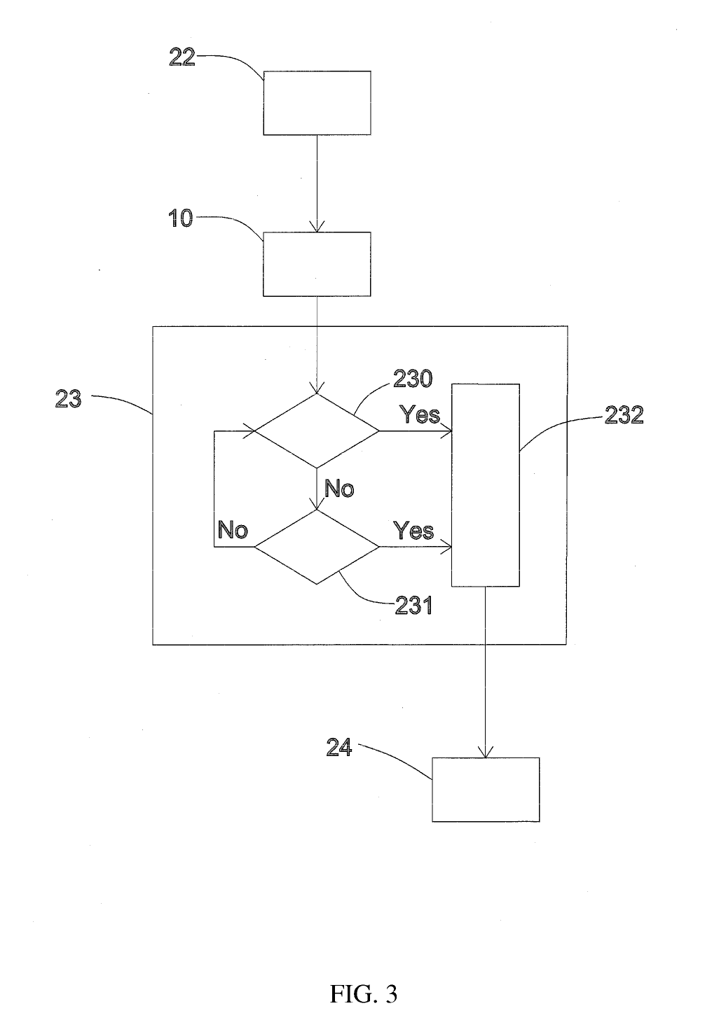

Referring to FIG. 3, in the implementation example of coffee preparation of the present invention, the client end pours hot water over the drink preparation container 4 filled with coffee powder, and the electronic scale 1 collects the drink weighing information 10. The electronic scale 1 records a piece of drink weighing information 10 at every interval of 0.2 seconds, and uses the Bluetooth chipset module 14 to wirelessly transmit the drink weighing information 10. The client-end device 2 wirelessly receives the drink weighing information 10 transmitted by the electronic scale 1 through the Bluetooth chipset 20. The app 22 uses the judgment mechanism 23 to judge and filter the drink weighing information 10. The water suspension judgment unit 230 of the judgment mechanism 23 is to judge if the drink weighing information 10 has a weight variation of 0.1 g within 1 second, if yes, the previous weight output is maintained; if not, enter into the water inlet judgment unit 231, which is to judge if the drink weighing information 10 has increase of weights within 1 second, if yes, the water inlet judgment unit calculates and outputs an average value of the multiple weight values within 1 second, if not, return to the water suspension status judgment 240. The graphic output unit 232 can compute the drink weighing information 10 continuously judged within 1 second by the water suspension status judgment 240 and the water inlet judgment unit 231, draw a flow rate curve 24 with a smooth line and output it on the displaying interface 25. In implementation, the client-end device 2 is networked with a server 3 through the app 22, and captures a selected control group of drink weighing information 301 from the database 30. The control group of drink weighing information 301 is planned into a flow rate curve 302 with diagrammed time and weight. The user refers to the flow rate curve 302 displayed on the displaying interface 25 during actual preparation of the coffee, and controls the hot water pouring into the drink preparation container 4 filled with coffee powder, making a flow rate curve 24 with its initial first stage being the first Pour Section 242 as a rising slope, continued by the Blooming Section 243 as a horizontal line, the second Pour Section 244 as a rising slope, and the Suspension Section 245 as a horizontal line, wherein the Blooming Section 243 and Suspension Section 245 are judged by the water suspension judgment unit 230 and output on the graphic output unit 232, the first Pour Section 242 and second Pour Section 244 are judged by the water inlet judgment unit 230 and output on the graphic output unit 232. The dynamic weight displaying zone 241 displays the weights on the displaying interface 25. The pouring is controlled and kept along the planned flow rate curve 302 indicated by the dotted line till it reaches the target weight displaying zone 240 and then it enters into the Suspension Section 245 and water pouring is suspended.

To summarize, the present invention uses a client-end device 2 with wireless transmission function to connect with an electronic scale 1 and a server 3 for real-time and direct-view manual coffee preparation based on a selected control group of drink weighing information 301, so that the weighing information during the drink preparation can be diagrammed by the electronic scale 1 and compared with the control group in a direct-view manner. In this way, beginners can learn to prepare coffee drinks with consistent and expert-level quality. Meanwhile, the drink weighing information 10 during the preparation process can be saved in the database 30 as multimedia archive information for future record and review, comparative learning, sharing and discussion. By combining a handheld device, a server database and an electronic scale, the present invention realizes an easy and practical new way for drink preparation with direct-view operation. It is indeed an invention with significant innovation and advancement.

Although the invention has been explained in relation to its preferred embodiment, it is to be understood that many other possible modifications and variations can be made without departing from the spirit and scope of the invention as hereinafter claimed.

1. A drink preparation method using a direct-view type dynamic displaying interface, i.e., the user manually pours water into the drink preparation container filled with raw material and placed on the electronic scale; during the pouring, the electronic scale collects the drink weighing information and wirelessly transmits it to the client-end device; the client-end device computes the drink weighing information and illustrates the information with a flow rate curve; the planned and diagrammed flow rate curve of a control group of drink weighing information is compared for learning to prepare consistent drinks in a direct-view manner.

2. The drink preparation method using a direct-view type dynamic displaying interface as claimed in claim 1, wherein the drink preparation raw material can be coffee powder, tea, wine, and food.

3. The drink preparation method using a direct-view type dynamic displaying interface as claimed in claim 1, wherein the client-end device can be mobile phone, tablet computer, or any other type of handheld electronic device.

4. The drink preparation method using a direct-view type dynamic displaying interface as claimed in claim 1, wherein the electronic scale has a scale top, with a built-in load cell, a signal processing unit, a processor, and a Bluetooth chipset module; the load cell senses the drink weighing information of the drink placed on the scale top, and the information is magnified and filtered by the signal processing unit; during the preparation, the processor detects the variations of the drink weighing information at regular intervals; the Bluetooth chipset module wireless transmits the drink weighing information to the client-end device in real time.

5. The drink preparation method using a direct-view type dynamic displaying interface as claimed in claim 4, wherein the client-end device has at least one built-in central processor, a Bluetooth chipset matching the Bluetooth chipset module of the electronic scale, a displaying interface and an app; through the Bluetooth chipset, the central processor wirelessly receives the drink weighing information transmitted by the Bluetooth chipset module of the electronic scale, and send it to the app having a judgment mechanism; the judgment mechanism judges and computes the drink weighing information and outputs it on the displaying interface.

6. The drink preparation method using a direct-view type dynamic displaying interface as claimed in claim 5, wherein the judgment mechanism has a water suspension status judgment unit, a water inlet status judgment unit, and outputs the judgments to a graphic output unit; the drink weighing information is respectively judged and filtered by the water suspension judgment unit and the water inlet judgment unit; the water suspension judgment unit judges if the drink weighing information of the drink on the electronic scale has increase of weight in one unit time; the water inlet judgment unit judges if the drink weighing information of the drink on the electronic scale has an overweight exceeding the set value in one unit time; the drink weighing information is output by the graphic output unit; the graphic output unit outputs the judged and computed drink weighing information, and draws a flow rate curve with diagrammed time and weight, and displays it on the displaying interface.

7. The drink preparation method using a direct-view type dynamic displaying interface as claimed in claim 6, wherein the flow rate curve forms more than one Pour Section, Blooming Section and Suspension Section, and has a target weight displaying zone, a dynamic weight displaying zone; the displaying interface is further configured with a multimedia displaying zone that can display multimedia information and an information zone that can display status.

8. The drink preparation method using a direct-view type dynamic displaying interface as claimed in claim 1, wherein the client-end device is connected with a server through wireless Ethernet; the server has a built-in database and the database is stored with at least one control group of drink weighing information, which can be accessed by any client-end device through wireless Ethernet to capture and save the information; the client-end device can capture any control group of drink weighing information in the database of the server, and can save the drink weighing information of the drink preparation process in the database to become a control group of drink weighing information as a drink preparation record that can be shared with others.
